(19) United States
(12) Patent Application Publication
(10) Pub. No.: US 2013/0043722 A1
(43) Pub. Date: Feb. 21, 2013

(54) DC TRAILING CABLE SYSTEM FOR TETHERED MINING VEHICLES

(71) Applicant: Bonne W. Posma, Fort Myers, FL (US)

(72) Inventor: Bonne W. Posma, Fort Myers, FL (US)

(73) Assignee: Saminco Inc.

(21) Appl. No.: 13/585,186

(22) Filed: Aug. 14, 2012

Related U.S. Application Data
(60) Provisional application No. 61/573,037, filed on Aug. 15, 2011.

(51) Int. Cl. B60L 1/00

(52) U.S. Cl. 307/9.1

(57) ABSTRACT

A DC trailing cable system for tethered machines is disclosed. The DC trailing cable system may include a power center configured to provide DC power having a controlled voltage value. In addition, the DC trailing cable system may include a tethered machine comprising one or more inverters and one or more motors, wherein the one or more inverters are supplied DC power, at least in part, from the power center via a two-core trailing cable, and wherein the one or more inverters are connected to the one or more motors.

### CROSS-REFERENCE TO RELATED APPLICATIONS

This application claims the benefit of U.S. Provisional Application No. 61/573,037, filed Aug. 15, 2011, which is incorporated herein by reference.

### TECHNICAL FIELD

The present disclosure relates to tethered electric vehicles and other moving machinery, and, more particularly, methods and systems for tethered electric vehicles and moving machinery generally used, for example, in above ground and underground mining.

### BACKGROUND

Electric vehicles and other moving machinery often receive power from an external source via a cable. Such tethered electric vehicles and machines are commonly supplied with three-phase AC electric power. Tethered electric vehicles and machines in such three-phase AC electric power systems are typically connected to an AC electric power source via three-core or four-core cables having lengths of up to 200 meters.

FIG. 1 depicts one example of a three-phase AC trailing cable system for a tethered shuttle car 3. As depicted in FIG. 1, a three-phase AC trailing cable system may include four AC induction motors, such as, for example: two variable frequency driven AC traction motors 9a, 9b; a fixed speed AC conveyor motor 13; and a fixed speed AC pump motor 12. In addition, a three-phase AC trailing cable system may include, for example: a power center 1 containing a 1,100 V AC secondary transformer; a three-core AC trailing cable 2; an EMC filter 5; two sets of three-phase inductors 6a, 6b; two active front end (AFE) rectifiers 7a, 7b; two sets of DC link capacitors 14a, 14b; and two variable frequency traction inverters 8a, 8b. The fixed speed AC pump motor 12 may be switched on and off by means of pump contactor 10 and conveyor motor 13 may be controlled by conveyor contactor 11. At full power, for a 20-ton shuttle car, for example, variable frequency drive (VFD) components 5, 6a, 6b, 7a, 7b, 8a, 8b, pump contactor 10, and conveyor contactor 11 may produce approximately 10 kW of heat that has to be removed from an explosion-proof (XP) enclosure by means of heat exchanger 15.

Three-core and four-core cables, such as those required by the example three-phase AC trailing cable system depicted in FIG. 1, are often heavy, unwieldy, and subject to overheating and frequent damage. In addition, such cables, when damaged, may take a long time to repair. Further, when such cables are used in underground coal mining, some jurisdictions prohibit the repair of underground damaged cables, requiring the entire cable to be removed from the vehicle and repaired above ground. Such issues can result in electric vehicles and other moving machinery being out of service for long periods of time.

In addition, in the arrangement depicted in FIG. 1, the three-phase inductors, AFE rectifiers, and DC/AC traction inverters may generate a relatively large amount of heat. To prevent heat damage, a significant portion of such heat must be dissipated by the enclosure in which these devices are housed. However, in some instances, so much heat is generated that it is necessary to have a worker manually cool the enclosure at regular intervals to avoid overheating (e.g., cooling the enclosure with water from a hose). Moreover, various elements, such as pumps, conveyors, and larger AC motors, cannot be controlled by existing control systems that allow for variable speed control because such control systems generate too much heat and occupy too much space for an AC trailing cable system.

Improvements in tethered electric machinery systems, such as tethered electric machinery systems that use less copper, are less likely to be damaged, are less subject to heating, can quickly be repaired underground, utilize longer cable lengths, utilize lower cost replacement cables, utilize on-board control systems that generate less heat, provide variable speed control of various elements, and/or provide energy consumption savings, are desirable.

### SUMMARY

In one disclosed embodiment, a DC trailing cable system is disclosed. The DC trailing cable system comprises a power center configured to provide DC power having a controlled voltage value. In addition, the DC trailing cable system comprises a tethered machine comprising one or more inverters and one or more motors, wherein the one or more inverters are supplied DC power, at least in part, from the power center via a two-core trailing cable, and wherein the one or more inverters are connected to the one or more motors.

In another disclosed embodiment, a machine is disclosed. The machine comprises one or more motors and one or more inverters. The one or more inverters are supplied DC power having a controlled voltage value, at least in part, from a power center via a two-core trailing cable. In addition, the one or more inverters are connected to the one or more motors.

In another disclosed embodiment, a power center is disclosed. The power center comprises one or more rectifiers, a residual current ground fault detection system, and a DC power output configured to provide DC power having a controlled voltage value and further configured to connect to a two-core trailing cable.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example AC trailing cable system for tethered shuttle car with AC induction motors.

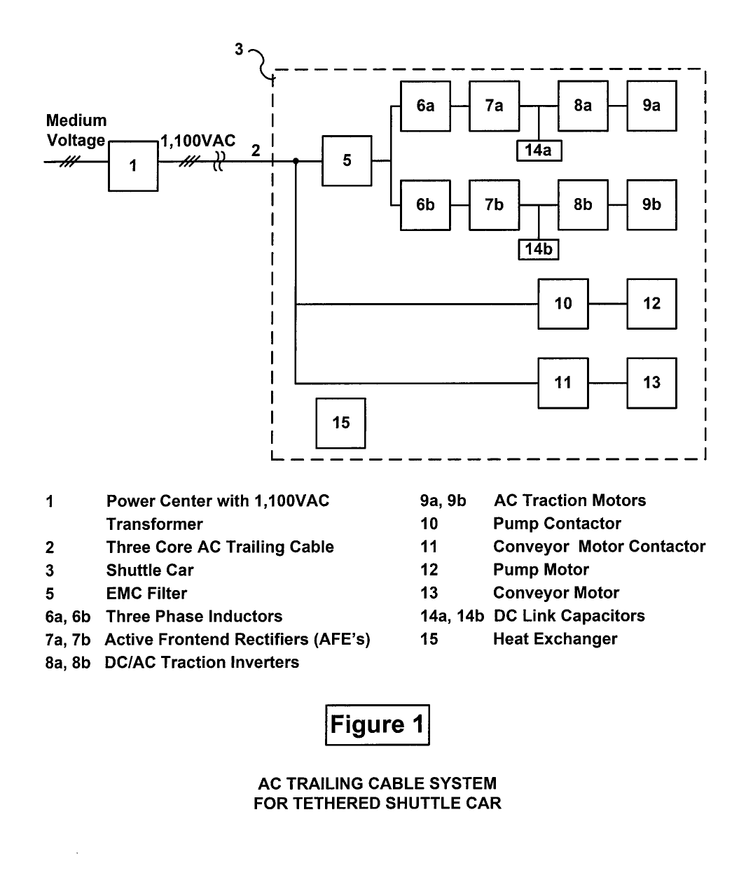

FIG. 2 illustrates an example comparison of waveforms in AC and DC trailing cables.

FIG. 3 illustrates an example DC trailing cable system for tethered shuttle car with AC induction motors.

FIG. 4 illustrates an example embodiment of a DC power supply system mounted in a power center.

### DETAILED DESCRIPTION

Reference will now be made in detail to the example embodiments, examples of which are illustrated in the accompanying drawings. Wherever possible, the same reference numbers will be used throughout the drawings to refer to the same or like parts.

Various embodiments for implementing a DC tethered cable system to provide electric power to electric vehicles and other machinery are disclosed. Such DC tethered cable systems may provide DC power to DC/AC inverters controlling on-board AC induction motors used, for example, for propulsion, hydraulic pumping, and cutter head applications. DC/AC inverters may be housed in suitable enclosures, including explosion-proof (XP) enclosures, mounted on or in the vehicle or other machine. In addition, such DC tethered cable systems may utilize two-core cables, rather than three-core or four-core cables to deliver DC power to the vehicle or other machine.

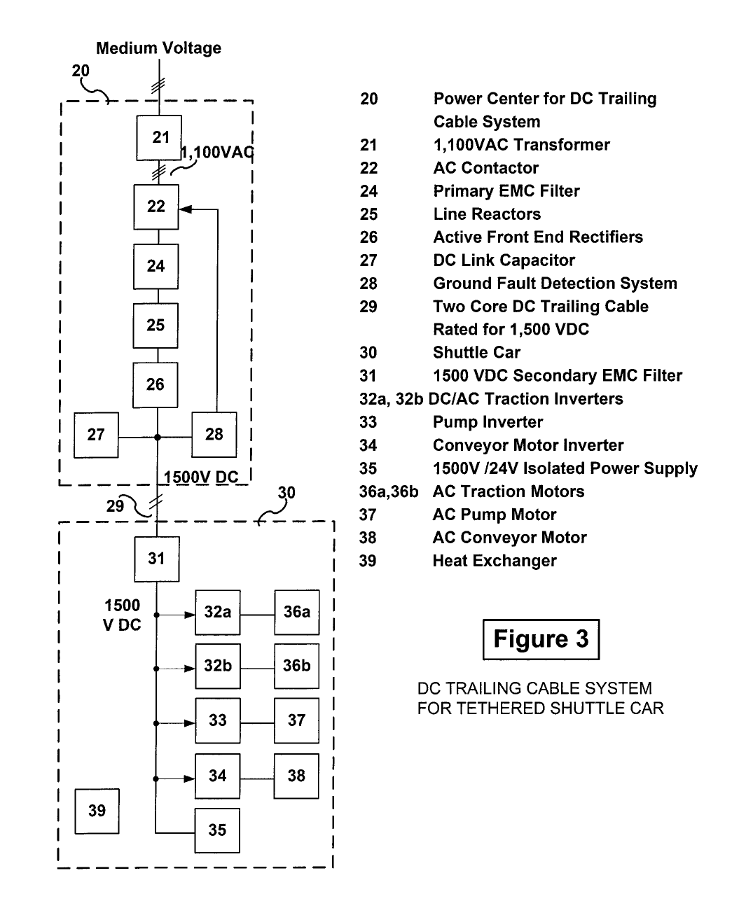

FIG. 3 depicts an example DC trailing cable system for a tethered shuttle car 30. In some embodiments, the example DC trailing cable system includes a power center 20, which contains transformer 21, isolation contactor 22, primary EMC filter 24, line reactors 25, active front end rectifier 26, DC link capacitor 27, and ground fault detector 28, which interrupts the AC supply via contactor 22 in the event of a ground fault in either the DC trailing cable 29 or shuttle car 30. In some embodiments, transformer 21 outputs 1,100 V AC and the power center 20 outputs 1,500 V DC. However, transformer 21 may be configured to output other AC voltages and power center 20 may be configured to output other DC voltages.

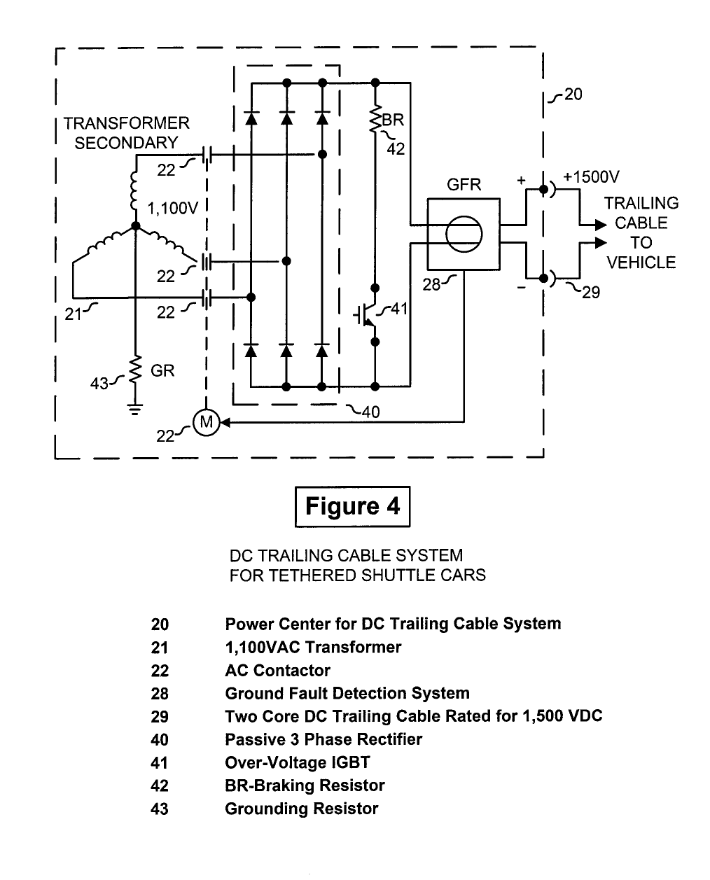

FIG. 4 depicts another embodiment of power center 20. In the embodiment depicted in FIG. 4, the DC power supply may include a passive rectifier 40 connected to power transformer 21 and energy absorbing resistor 42 together with an over-voltage sensing IGBT switch 41. A residual current ground fault detection system 28 may trip if a current imbalance of 100 mA DC or greater occurs, indicating a ground fault. In response to the ground fault detection system 28 tripping, power from the rectifier may be removed via AC contactor 22. Grounding resistor 43 limits ground fault current in the event of a bolted fault to ground.

Returning to the DC trailing cable system depicted in FIG. 3, in some embodiments 1,500 V DC is supplied to the shuttle car 30 from the power center 20 via the two-core trailing cable 29. However, in alternative embodiments, various other DC voltage levels may be supplied to the shuttle car 30 by the power center 20. In some embodiments, the DC power received by the shuttle car passes through secondary EMC filter 31. However, in other embodiments, secondary EMC filter 31 may be omitted. In some embodiments, the DC power received from the power center is supplied, directly or indirectly, to DC/AC Traction Inverters 32a and 32b which control AC traction motors 36a and 36b. In addition, in some embodiments, the DC power received from the power center is supplied, directly or indirectly, to DC/AC pump inverter 33 which controls AC pump motor 37. In addition, in some embodiments, the DC power received from the power center is supplied, directly or indirectly, to DC/AC conveyor motor inverter 34 which controls AC conveyor motor 38. In some embodiments, shuttle car 30 may be configured to use one or more permanent magnet motors, switched reluctance motors, or DC motors in place of one or more of the AC motors. In addition, in some embodiments, the DC power received from the power center is supplied, directly or indirectly, to DC/DC power supply 35 which may output 24 V DC. An optional 24 V DC heat exchanger 39 may be fitted to remove the heat generated by the inverters. In some embodiments, such a heat exchanger is only used for heavy duty applications, such as, for example, for shuttle cars rated for more than 20 tons.

Using the disclosed embodiments, up to 60% of the heat that would be generated in an AC trailing cable system may be moved to the power center which has enough space to allow for adequate cooling. Moreover, relatively large components such as the primary EMC Filter, line reactor, active front end rectifier, and primary DC link capacitor may be placed in the power center and not in the limited space of the shuttle car, thus allowing space in the shuttle car for inverters for the conveyor motor 38 and pump motor 37, which permits variable speed operation of the conveyor motor 38 and pump motor 37.

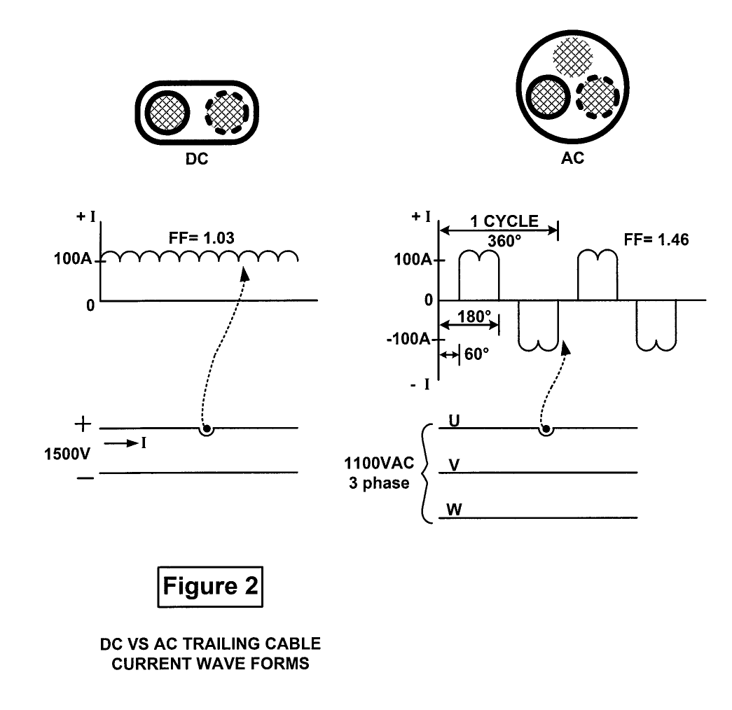

FIG. 2 shows example comparative waveforms of a three-phase AC trailing cable system and a DC trailing cable system. In an AC cable system with a rectifier onboard the vehicle, there is no current flow in each of the three conductors for 120 degrees of a cycle, resulting in current waveforms with a considerable amount of parasitic ripple current that does not contribute to energy transfer from the electrical power source that ultimately results in useful motor torque. In contrast, a DC trailing cable system transfers electrical energy continuously, with little parasitic ripple current. This difference in current flow results in a DC trailing cable system being associated with a relatively lower form factor than an AC trailing cable system (e.g., as depicted in FIG. 2, a DC trailing cable system may be associated with a form factor of 1.03 while an AC trailing cable system may be associated with a form factor of 1.46). Lower form factors are typically associated with better motor performance and less heat generation. Moreover, DC trailing cables are usually manufactured in a flat configuration, in contrast to the round configuration of AC trailing cables, resulting in better heat transfer to the environment. Thus, for the same amount of power required at the shuttle car, a DC trailing cable requires up to 50% less copper than an AC trailing cable.

Other embodiments of the invention will be apparent to those skilled in the art from consideration of the specification and practice of the invention disclosed herein. It is intended that the specification and example be considered as exemplary only, with a true scope and spirit of the invention being indicated by the following claims.

What is claimed is:

1. A DC trailing cable system, comprising:
a power center configured to provide DC power having a controlled voltage value; and
a tethered machine comprising one or more inverters and one or more motors,
wherein the one or more inverters are supplied DC power, at least in part, from the power center via a two-core trailing cable, and
wherein the one or more inverters are connected to the one or more motors.

2. The system of claim 1, wherein the one or more motors are one or more AC induction motors.

3. The system of claim 1, wherein the one or more motors are one or more permanent magnet motors, switched reluctance motors, or DC motors.

4. The system of claim 1, wherein the power center further comprises one or more rectifiers and a residual current ground fault detection system.

5. The system of claim 1, wherein the machine is a vehicle.

6. The system of claim 1, wherein the voltage value is 1500 V DC or approximately 1500 V DC.

7. A machine, comprising:
one or more motors, and
one or more inverters,
wherein the one or more inverters are supplied DC power having a controlled voltage value, at least in part, from a power center via a two-core trailing cable, and
wherein the one or more inverters are connected to the one or more motors.

8. The machine of claim 7, wherein the one or more motors are one or more AC induction motors.

9. The machine of claim 7, wherein the one or more motors are one or more permanent magnet motors, switched reluctance motors, or DC motors.

10. The machine of claim 7, wherein the machine is a vehicle.

11. The machine of claim 7, wherein the voltage value is 1500 V DC or approximately 1500 V DC.

12. A power center, comprising:
one or more rectifiers;
a residual current ground fault detection system; and
a DC power output configured to provide DC power having a controlled voltage value and further configured to connect to a two-core trailing cable.

13. The power center of claim 12, wherein the voltage value is 1500 V DC or approximately 1500 V DC.
